(19) United States
(12) Patent Application Publication
(10) Pub. No.: US 2004/0089458 A1
(43) Pub. Date: May 13, 2004

(54) Vehicle for fighting forest fires

(76) Inventor: Autry Lee Jones, Florence, CO (US)

Correspondence Address: Kevin L. Russell, Suite 1600, 601 SW Second Ave., Portland, OR, 97204-3157, US

(21) Appl. No.: 10/288,693

(22) Filed: Nov. 4, 2002

(51) Int. Cl. A62C 27/00

(52) U.S. Cl. 169/24

(57) ABSTRACT

A fire fighting vehicle comprises a chassis mounted on a traction system for moving across broken ground. The vehicle includes a water tank connected to the chassis. A cutting device is mounted at a forward end of the chassis and extends in a forward direction away from the chassis. A first arm is pivotally mounted to the chassis, the first arm being capable of extending in a forward direction away from the chassis, the first arm terminating at a distal end in a grasping mechanism. A second arm is pivotally mounted to the chassis, the second arm terminating in a blower. The second arm supports a line interconnecting the water tank to the blower. The second arm is capable of extending the blower away from the chassis and pivoting the blower 180° about the chassis.

### BACKGROUND OF THE INVENTION

The present invention relates to a vehicle for fighting forest fires, and in particular to a vehicle capable of traveling over rough ground and spraying water over substantial distances to fight fires.

Firefighters encounter numerous difficulties when fighting forest fires. One such difficulty is that forest fires are often in remote areas which are difficult to access. Conventional fire trucks require maintained roads to travel throughout a forest. However, the location of the fire may be miles beyond a road. In such instances, firefighters must battle fires on foot from the ground and leave their vehicles behind.

Another difficulty is that access to the forest fire may be blocked. Standing or fallen timber may prevent vehicles from entering the forest. If a conventional fire truck encounters obstacles in its path, it must wait for a fire crew to remove the obstacle by hand or with other heavy equipment.

Yet another difficulty is that the fires cause intense heat. The firefighters may be prevented from reaching the source of fire due to the flames and heat generated by the burning trees and debris. Firefighters who lack heavy equipment on the ground cannot actively extinguish such fires, but instead seek to stop the spread of the fire by cutting firebreaks around the fire. For large fires, it may be necessary to extinguish the fire over a very large path.

What is therefore desired is a fire fighting vehicle for use with fighting forest fires that is capable of moving through roadless areas, that can remove or negotiate obstacles such as standing or downed timber, and that is capable of extinguishing even large, intense fires from a substantial distance.

### SUMMARY OF THE INVENTION

The present invention is directed toward a fire fighting vehicle that is capable of moving through roadless areas, that can remove or negotiate obstacles such as standing or downed timber, and that is capable of extinguishing even large, intense fires from a substantial distance. The fire fighting vehicle comprises a chassis mounted on a traction system for moving across broken ground. The vehicle includes a water tank connected to the chassis. A cutting device is mounted at a forward end of the chassis and extends in a forward direction away from the chassis. A first arm is pivotally mounted to the chassis, the first arm being capable of extending in a forward direction away from the chassis, the first arm terminating at a distal end in a grasping mechanism. A second arm is pivotally mounted to the chassis, the second arm terminating in a blower. The second arm supports a line interconnecting the water tank to the blower. The second arm is capable of extending the blower away from the chassis and pivoting the blower 180° about the chassis.

The invention has the advantage that it is capable of fighting forest fires in roadless areas. The vehicle can remove obstacles by cutting and removing trees, debris or other brush through the use of the cutting device and first arm. The second arm allows fires to be extinguished from a substantial distance by blowing water at high velocity toward the fire.

The foregoing and other objectives, features and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a perspective view of a self-propelled fire fighting vehicle.

FIG. 2 is a side view of said fire fighting vehicle showing the vehicle connected to a water tank.

FIG. 3 is a top plan view of the fire fighting vehicle.

### DETAILED DESCRIPTION OF THE PREFERRED EMBODIMENT

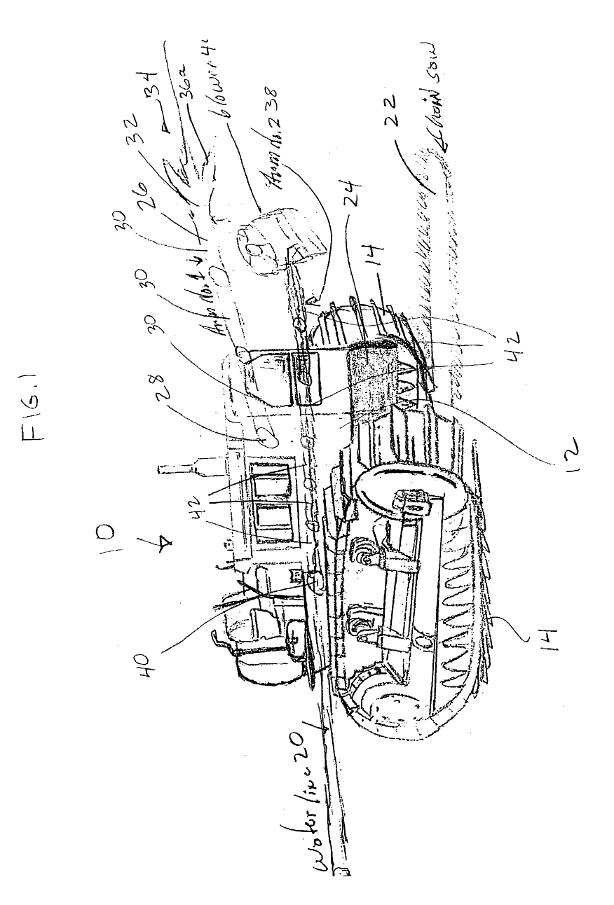

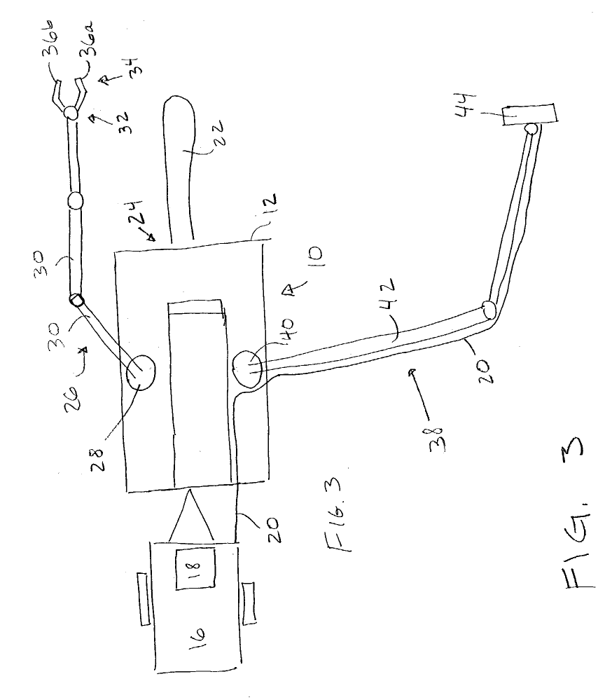

Reference is now made to the FIGS. 1-3, wherein a fire fighting vehicle is shown and in which like numerals refer to like elements. FIGS. 1-3 show a self-propelled fire fighting vehicle 10. The vehicle 10 includes a chassis 12 mounted on a traction system, such as a pair of caterpillar tracks 14, for moving across broken ground. The vehicle is capable of negotiating off-road terrain. The chassis and tracks may be from a conventional bulldozer, truck or like vehicle. The vehicle may range in size, but should have the capability of carrying or towing at least one or two water tanks. The motor of the vehicle should have sufficient horsepower to be capable of operating the various pieces of equipment attached to the vehicle as described in more detail below.

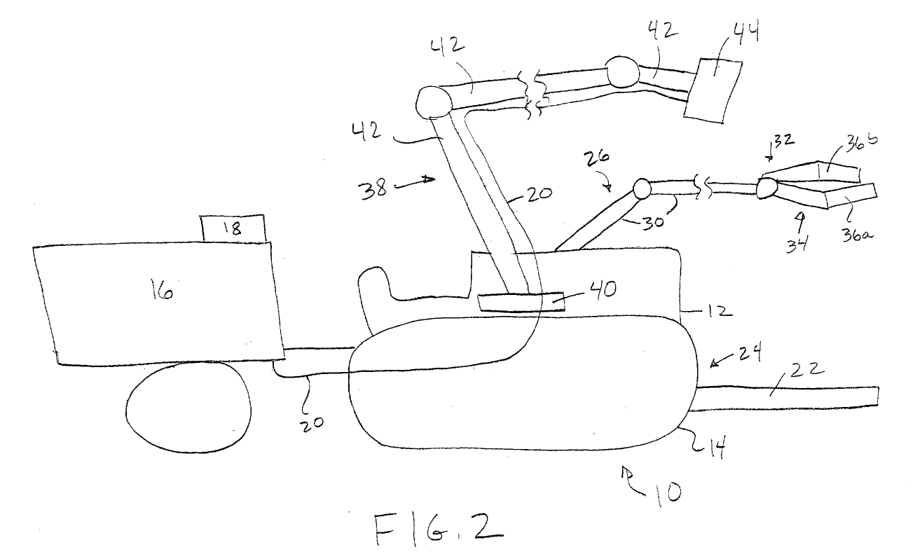

The vehicle 10 also includes at least one water tank 16 connected to the chassis. As illustrated in FIG. 2, the water tank may be towed behind the vehicle. Alternatively, the water tank 16 may be mounted to the chassis 12 itself. The vehicle 10 may include more than one water tank 16. The water tank 16 may range in size. However, it is preferred that the water tank 16 be sufficiently large so that the vehicle is capable of extinguishing large fires. Thus, the water tank 16 preferably is capable of carrying several thousand gallons of water. As shown in FIG. 2, the water tank 16 has a pump 18 associated with it to pump water out of the tank 16 into a line 20 for spraying water onto the fire. The pump 18 may be a motor mounted to the tank which forces air into the tank 16, thus forcing water out of the tank and into the line 20.

The vehicle 10 also includes a cutting device 22 mounted at a forward end 24 of the chassis 12 and extending in a forward direction away from the chassis 12. As shown in FIG. 1, the cutting device 22 may be a chain saw. The function of the cutting device 22 is to cut timber, brush or other material which may be an obstacle to the vehicle. Preferably, the cutting device 22 extends sufficiently forward of the vehicle 10 so that large trees may be cut down and removed. The cutting device 22 may be pivotally connected to the undercarriage of the chassis 12 so as to be capable of moving relative to the vehicle 10. The cutting device 22 may be operatively connected to the motor of the vehicle, such as mechanically as by a belt or other link to a drive shaft, so that the motor may provide power to the cutting device 22.

The vehicle 10 also includes a first arm 26 pivotally mounted to the chassis 12. The first arm 26 is used to remove obstacles or other debris which may block the vehicle 10 from reaching the fire. The first arm 26 is intended to be used in tandem with the cutting device 22. The first arm 26 should be capable of extending in a forward direction away from the chassis 12 so as to grasp trees which are being cut by the cutting device 22, or to reach other obstacles. The first arm 26 is mounted to the chassis 12 on a rotating platform 28 so as to be capable of pivoting about the vehicle 10. The first arm 26 may be comprised of several articulated segments 30 to allow the first arm to bend. In one embodiment, the first arm comprises three segments 30 each about fifteen feet long. The first arm 26 may be assembled using any conventional assembly known for building moveable booms, arms or cranes, and may be operatively interconnected with the motor of the vehicle 10 for power.

To facilitate removal of trees or obstacles, the first arm 26 terminates at a distal end 32 in a grasping mechanism 34. The grasping mechanism 34 may be comprised of a pair of pincers 36a and 36b. The pincers 36 are capable of moving toward and away from each other so as to grasp obstacles or cut trees. The pincers 36 may be controlled by any conventional device suitable for moving the pincers 36. Exemplary devices would be a hydraulic fluid system, or a cable system connected to pulleys to open and close the pincers. Such a device may be operatively interconnected with the motor of the vehicle 10 for power.

The vehicle 10 also includes a second arm 38 pivotally mounted to the chassis 12. The second arm 38 is used to spray water onto the fire. The second arm 38 should be capable of extending in a forward direction away from the chassis 12 so as to spray water at trees or other burning material. The second arm 38 is mounted to the chassis 12 on a rotating platform 40 so as to be capable of pivoting about the vehicle 10. The second arm 38 may pivot 180° to 360° around the vehicle 10. The second arm 38 may be comprised of several articulated segments 42 to allow the second arm 38 to bend. In one embodiment, the second arm 38 comprises a plurality of segments 42 each about fifty feet long, such that the second arm 42 is capable of extending about 350 feet on either side of the vehicle. The second arm 38 may be assembled using any conventional assembly known for building moveable booms, arms or cranes. The second arm 38 may be operatively interconnected with the motor of the vehicle 10 for power.

The second arm 38 terminates in a blower 44 for spraying water from the second arm 38 onto the fire. The blower 44 should be capable of generating a sufficient velocity of air so as to spray water a substantial distance. The blower 44 may be powered by the chassis motor, either by electrical, mechanical or hydraulic means. The second arm 38 supports the line 20 interconnecting the water tank 16 to the blower 44. Thus, in use, the second arm 38 is capable of extending the blower 44 away from the chassis 12 and pivoting the blower 44 at least 180° to 360° about the chassis 12. In one embodiment, the blower 44 is capable of generating an air velocity of at least 75 mph so as to spray the water a substantial distance, and the second arm 38 is 350 feet long so as to make a pass of 700 feet through a fire.

Thus, the vehicle as described is capable of fighting forest fires in roadless areas due to the use of a traction system such as the caterpillar tracks. The vehicle can remove obstacles by cutting and removing trees, debris or other brush through the use of the cutting device and the first arm. The second arm allows fires to be extinguished from a substantial distance by blowing water at high velocity toward the fire.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

I claim:

1. A fire fighting vehicle, comprising:
(a) a chassis mounted on a traction system for moving across broken ground;
(b) a water tank connected to said chassis;
(c) a cutting device mounted at a forward end of said chassis and extending in a forward direction away from said chassis;
(d) a first arm pivotally mounted to said chassis, said first arm capable of extending in a forward direction away from said chassis, said first arm terminating at a distal end in a grasping mechanism; and
(e) a second arm pivotally mounted to said chassis, said second arm terminating in a blower, said second arm supporting a line interconnecting said water tank to said blower, and said arm being capable of extending said blower away from said chassis and pivoting said blower 180° about either side of said chassis.

2. The vehicle of claim 1 wherein said water tank is towed by said chassis.

3. The vehicle of claim 1 wherein said cutting device is a chain saw mounted beneath said chassis.

4. The vehicle of claim 1 wherein said gasping mechanism comprises a pair of pincers.

5. The vehicle of claim 1 wherein said second arm is capable of rotating 360° around said vehicle.
